(19) United States
(12) Patent Application Publication
(10) Pub. No.: US 2008/0099954 A1
(43) Pub. Date: May 1, 2008

(54) Solution Casting Method

(75) Inventors: Kojyu Ito, Kanagawa (JP); Satoshi Sakamaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku (JP)

(21) Appl. No.: 11/887,549

(22) PCT Filed: Mar. 24, 2006
(86) PCT No.: PCT/JP2006/306776

§ 371 Date: Dec. 18, 2007

(30) Foreign Application Priority Data
Mar. 30, 2005 (JP) 2005-099206

(51) Int. Cl. B29D 7/01

(52) U.S. Cl. 264/217; 264/212

(57) ABSTRACT

A dope is prepared from TAC, mixed solvent and additive. The dope is cast from a casting die (31) onto a belt (34). A casting film (69) is formed on the belt (34). The casting film (69) is carried in association with movement of the belt 34. A rapid-drying blower unit (73) is disposed at a position, which is separated from a labyrinth seal (50) by 1000 mm in a downstream direction. Dry air (57) is applied to the casting film from a nozzle (73a) of the blower unit (73). Velocity of the dry air (57) is adjusted to 12 m/s. An initial film (69a) is formed on the casting film (69). The entire casting film (69) is dried after forming the initial film (69a). The casting film (69) is peeled from the belt (34) after having a self-supporting property. The casting film is heated and stretched in a tenter drier and is dried in a drying chamber.

### TECHNICAL FIELD

The present invention relates to a solution casting method for producing a film to be used for an optical film.

### BACKGROUND ART

A cellulose triacetate (herein after referred to as TAC) film is utilized as a film support of a photographic sensitive material in view of toughness and flame retardance. The TAC film is formed from TAC, which is a sort of cellulose ester and has an average degree of acetylation of 58.0% to 62.5%. Since the TAC film is also excellent in optical isotropy, this film is used for a protective film of a deflection plate of a liquid-crystal display having been widespread in recent years, for instance.

The TAC film is normally produced by a solution casting method. In comparison with the other production method of a melt casting method and so forth, it is possible by the solution casting method to produce a film having excellent optical properties and so forth. In the solution casting method, a polymer solution (herein after referred to as dope) is prepared by dissolving a polymer in a mixed solvent of which primary constituents are dichloromethane and methyl acetate. The dope flows from a casting die onto a support in a state that casting beads are generated, and then a casting film is formed. After the casting film has possessed a self-supporting property on the support, this film (herein after referred to as wet film) is peeled from the support and is dried. The dried film is taken up (see Investigation and Research No. 2001-1745 issued by Japan Institute of Invention and Innovation, for instance).

In the solution casting method, dry air is applied to a surface of the casting film in order to facilitate drying thereof. However, if the casting film is rapidly dried, a surface condition thereof is likely to be deteriorated. In view of this, a method in which drying is gently performed is known (see Japanese Patent Laid-Open Publication No. 11-123732, for instance). In this kind of the method, a drying speed of the casting film is 300% by mass per minute (=5% by mass per second) or less when a solvent is included by an amount of drying standard. Further, a co-casting method for forming a casting film having a multi-layer structure is also known. Such a casting film has skin layers formed on both surfaces of a central layer regarded as an intermediate layer. In this case, dope viscosity of the central layer is increased to secure strength of the casting film, and at the same time, dope viscosity of the skin layer is decreased to improve smoothness of a surface thereof (see Japanese Patent Laid-Open Publication No. 2003-276037, for instance).

With respect to a film having functionality in virtue of recent orientation, slight unevenness of thickness is visually recognized in the solution casting method. Thus, flatness of the film is highly required. Under the conventional drying conditions, there arises a problem in that stripe-like unevenness and spotty-like unevenness are caused due to air velocity and so forth at the time of drying. The unevenness caused at the drying time is an especially big problem, which deteriorates quality of an optical film requiring excellent flatness. Meanwhile, in order to improve productivity of the film, it is performed to fasten not only the casting speed but also the drying speed. In this case, when the method described in the above-noted Publication No. 2001-1745 is used, there arises a problem in that the productivity of the film is deteriorated since the drying speed is lowered. Alternatively, when the method described in the above-noted Publication No. 2003-276037 is used, it is needed to perform multilayer casting. Thus, this method is sometimes unsuitable for the desired film.

It is an object of the present invention to provide a solution casting method in which a surface of a film becomes flat and smooth, and at the same time, productivity is improved.

### DISCLOSURE OF INVENTION

In order to achieve the above objects and other objects, the solution casting method according to the present invention comprises the steps of casting a dope from a casting die onto an endlessly moving support, and forming a casting film of the dope on the support. The dope includes a polymer and a solvent. The solution casting method further comprises the steps of drying a surface of the casting film to form an initial film thereon, and peeling the casting film from the support as a film. Forming the film is started from the initial film. In virtue of surface tension of the initial film, surface condition of the casting film becomes flat and smooth.

The inventors of the present application have found that unevenness of a stripe shape and a spotty shape are caused when natural air, velocity of which is 0.1 m/s or more and 3 m/s or less, covers the surface of the casting film for a certain period between a casting start position and a dry-air blower. In consideration of this, a transit time to be taken for passing an area of the natural air is shortened in the present invention. After the casting film has passed through the natural-air area, the casting film is rapidly dried to form the initial film. Incidentally, the initial film means a part of the film, which has lower content of volatile matter in comparison with a central portion thereof during the progress of drying the casting film surface.

In a preferable embodiment, the initial film is formed by applying dry air to the casting film. Before applying the dry air to the casting film, the surface of the casting film passes through an air, a velocity of which is less than 3 m/s, and a transit time thereof is set to 15 seconds or less. Velocity of the dry air is 3 m/s or more and 15 m/s or less. The dry air is applied to the casting film for 20 seconds or more. A gas concentration of the dry air is 25% or less. A temperature of the dry air is 40° C. or more and 120° C. or less.

Moreover, the initial film is formed within 15 seconds after the casting film has been formed on the support. A remaining solvent amount of the casting film is 300% by mass or more and 500% by mass or less on a dry basis at a time when drying the surface of the casting film is started.

Further, a diminution rate of the solvent included in the casting film is 1% by mass per second or more and 12% by mass per second or less on a dry basis until thirty seconds has passed after applying the dry air. At the time of casting, viscosity of the dope is 10 Pa·s or more and 100 Pa·s or less. A movement speed of the support is 10 m/minutes or more and 200 m/minute or less. The polymer is cellulose acylate. The film is used for an optical film.

According to the solution casting method of the present invention, it is possible to make the surface condition of the film flat and smooth. Further, it is possible to produce the film without using a special equipment and without lowering a casting speed.

### BRIEF DESCRIPTION OF DRAWINGS

FIG. 1 is a schematic illustration showing a film production line for executing a solution casting method of the present invention;

FIG. 2 is a partially enlarged view of FIG. 1; and

FIGS. 3A, 3B and 3C are illustrations showing other embodiments of a dry-air applying manner for executing the solution casting method.

### BEST MODE FOR CARRYING OUT THE INVENTION

Embodiments of the present invention are described below in detail. The present invention, however, is not limited to the following embodiments.

[Material]

In this embodiment, cellulose acylate is used as polymer. As to the cellulose acylate, triacetyl cellulose (TAC) is especially preferable. In the preferable cellulose acylate, a degree of acyl substitution relative to a hydrogen atom of cellulose hydroxyl satisfies all of the following formulae (I)-(III). In these formulae, A and B represent the degree of acyl substitution relative to the hydrogen atom of the cellulose hydroxyl, wherein A is a degree of substitution of acetyl group and B is a degree of substitution of acyl group having 3-22 carbon atoms. Preferably, at least 90 wt. % of the TAC particles has diameter from 0.1 mm to 4 mm.
2.5≦A+B≦3.0 (I)
0≦A≦3.0 (II)
0≦B≦2.9 (III)

Incidentally, the polymer to be used in the present invention is not limited to the cellulose acylate.

The cellulose is constructed of glucose units making β-1,4 combination, and each glucose unit has a liberated hydroxyl group at second, third and sixth positions. Cellulose acylate is a polymer in which part or whole of the hydroxyl groups are esterified so that the hydrogen is substituted by acyl groups having a carbon number of 2 or more. The degree of substitution for the acyl groups in cellulose acylate is a degree of esterification at second, third or sixth position in cellulose. Accordingly, when all (100%) of the hydroxyl group at the same position are substituted, the degree of substitution at this position is 1.

When the degrees of substitution for the acyl groups at the second, third or sixth positions are respectively described as DS2, DS3 and DS6, the total degree of substitution for the acyl groups at the second, third or sixth positions (namely DS2+DS3+DS6) is preferably in the range of 2.00 to 3.00, and particularly in the range of 2.22 to 2.90, and especially in the range of 2.40 to 2.88. Further, DS6/(DS2+DS3+DS6) is preferably 0.28 or more, and particularly 0.30 or more, and especially 0.31 to 0.34.

The sort of acyl group to be contained in the cellulose acylate of the present invention is may be only one, and two or more sorts of the acyl group may be contained. If the number of the sorts of the acyl groups is at least two, it is preferable that one of the sorts is acetyl group. If the total degree of substitution for the acetyl groups and that for other acyl groups at the second, third or sixth positions are respectively described as DSA and DSB, the value DSA+DSB is preferably in the range of 2.22 to 2.90, and particularly in the range of 2.40 to 2.88. Further, the DSB is preferably at least 0.30, and especially at least 0.7. Further, in the DSB, the percentage of a substituent at the sixth position is preferably at least 20%, particularly at least 25%, especially at least 30% and most especially at least 33%. Further, the value DSA+DSB at sixth position is at least 0.75, particularly at least 0.80, and especially 0.85. From cellulose acylate satisfying the above conditions, a solution (or dope) having a preferable dissolubility can be prepared. Especially when non-chlorine type organic solvent is used, the adequate dope can be prepared, since the dope can be prepared so as to have a low viscosity and the filterability becomes higher.

The cellulose being as the raw material of the cellulose acylate may be obtained from either of linter cotton and pulp cotton. However, the cellulose obtained from the linter cotton is preferable.

The acyl group having at least 2 carbon atoms may be aliphatic group or aryl group, and is not restricted especially. As examples of the cellulose acylate, there are alkylcarbonyl ester, alkenylcarbonyl ester, aromatic carbonyl ester, aromatic alkylcalbonyl ester and the like. Further, the cellulose acylate may be also esters having other substituents. The preferably substituents are propionyl, butanoyl, pentanoyl, hexanoyl, octanoyl, decanoyl, dodecanoyl, tridecanoyl, tetradecanoyl, hexadecanoyl, octadecanoyl, iso-butanoyl, t-butanoyl, cyclohexane carbonyl, oleoyl, benzoyl, naphtylcarbonyl, cinnamoyl and so forth. Among them, propionyl, butanoyl, dodecanoyl, octadecanoyl, t-butanoyl, oleoyl, benzoyl, naphtyl carbonyl, cinnamoyl and so forth are particularly preferable, and propionyl and butanoyl are especially preferable.

Solvent compounds for preparing the dope are aromatic hydrocarbon (for example, benzene toluene and the like), halogenated hydrocarbons (for example, dichloromethane, chlorobenzene and the like), alcohols (for example methanol, ethanol, n-propanol, n-butanol, diethylene glycol and the like), ketones (for example acetone, methylethyl ketone and the like), esters (for example, methylacetate, ethylacetate, propylacetate and the like), ethers (for example tetra hydrofuran, methylcellosolve and the like) and so forth. Incidentally, in the present invention, the dope means polymer fluid and dispersion liquid, which are obtained by dissolving or dispersing the polymer in a solvent.

The preferable solvent compounds are the halogenated hydrocarbons having 1 to 7 carbon atoms, and dichloromethane is especially preferable. In view of physical properties such as optical properties, a solubility of the TAC, a peelability from a support of a casting film, a mechanical strength of the film and the like, it is preferable to use at least one sorts of the solvent compounds having 1 to 5 carbon atoms with dichloromethane. The content of the alcohols is preferably in the range of 2% by mass to 25% by mass, and especially in the range of 5% by mass to 20% by mass to total solvent compounds in the solvent. As concrete example of the alcohols, there are methanol, ethanol, n-propanol, isopropanol, n-butanol, and the like. It is preferable to use methanol, ethanol, n-butanol or a mixture thereof.

Recently, for the purpose of reducing the influence on the environment, the solvent containing no dichloromethane is proposed. For this purpose, the solvent contains ethers with 4 to 12 carbon atoms, ketones with 3 to 12 carbon atoms, esters with 3 to 12 carbon atom, alcohol with a carbon number of 1 to 12, or a mixture of them. For example, there is a mixed solvent of methylacetate, acetone, ethanol and n-butanol. The ether, the ketone, the ester and the alcohol may have a cyclic structure. At least one solvent compound having at least two functional groups thereof (—O—, —CO—, —COO— and —OH) may be contained in the organic solvent.

The cellulose acylate is described in detail in the Japanese patent application No. 2004-264464, and the description of this application can be applied to the present invention. Further, as the solvent of cellulose acylate and other additives, this application discloses plasticizers, deteoriation inhibitor, ultraviolet (UV) absorber, optical anisotropy controlling agent, retardation controlling agent, dye, matting agent, peeling agent, release-accelerating agent and so forth in detail.

[Dope Producing Method]

The dope is produced by using the above-mentioned materials. First of all, the solvent is sent from a solvent tank to a dissolution tank. Successively, the TAC contained in a hopper is measured and sent to the dissolution tank. In addition, an additive solution is sent from an additive tank to the dissolution tank by a necessary amount. Incidentally, instead of sending the additive as solution, it is possible to send the additive to the dissolution tank in a liquid state when the additive is liquid at room temperature. Meanwhile, when the additive is solid, it is possible to send the additive to the dissolution tank by using a hopper and so forth. When plural kinds of the additives are added, the additive tank may contain a solution in which the plural kinds of the additives are dissolved. Alternatively, many additive tanks may be used for respectively containing a solution in which the additive is dissolved. In this case, the additive solutions are respectively sent to the dissolution tank through an independent pipe.

In the above description, the solvent (this term includes the mixed solvent), the TAC and the additive are sent to the dissolution tank in this order. However, this order is not exclusive. For example, the solvent of an appropriate amount may be sent after the TAC has been measured and sent to the dissolution tank. By the way, the additive is not necessarily contained in the dissolution tank beforehand. The additive may be mixed in a mixture of the TAC and the solvent (herein after, this mixture is sometimes referred to as dope) during a succeeding process.

The dissolution tank is provided with a jacket for covering an outer surface thereof, and a first stirrer rotated by a motor. It is preferable that the dissolution tank further includes a second stirrer rotated by a motor. Preferably, the first stirrer comprises an anchor blade and the second stirrer is a decentering stirrer of dissolver type. A temperature of the dissolution tank is regulated by letting heat transfer media flow between the dissolution tank and the jacket. A preferable range of the temperature is −10° C. to 55° C. The first stirrer and the second stirrer are properly selected and used to swell the TAC in the solvent so that a swelling liquid is obtained.

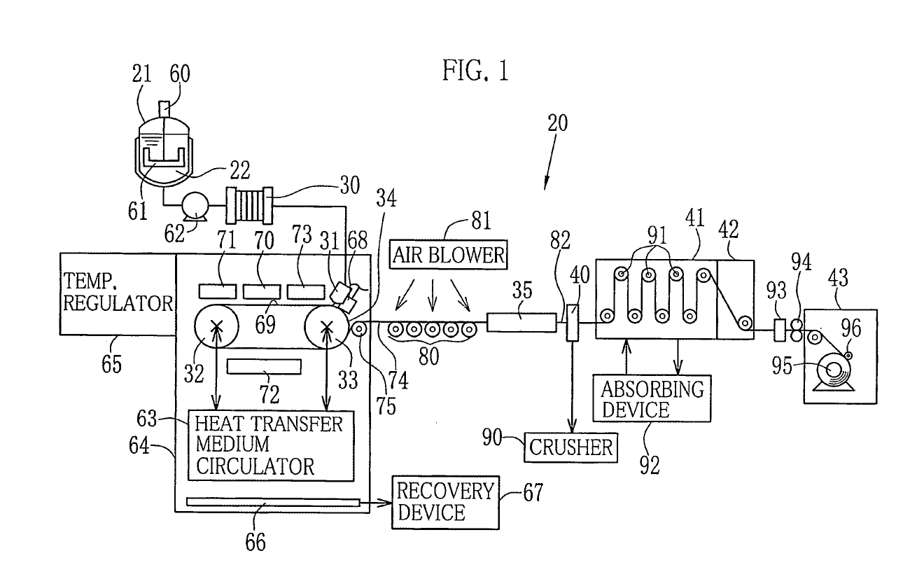

The swelling liquid is sent to a heater by a pump. It is preferable that the heater is piping with a jacket and has a structure capable of pressurizing the swelling liquid. By using this kind of the heater, solid contents of the swelling liquid are dissolved under a heating condition or a pressurizing/heating condition to obtain the dope. Hereinafter, this method is referred to as heating-dissolving method. In this case, it is preferable that the temperature of the swelling liquid is 50° C. to 120° C. Meanwhile, it is possible to perform a cool-dissolving method in which the swelling liquid is cooled to −100° C. to −300° C. The heating-dissolving method and the cool-dissolving method are properly selected and performed to sufficiently dissolve the TAC in the solvent. After the dope has reached a substantial room temperature by means of a temperature adjuster, the dope is filtered by a filtration device to remove impurities contained therein. It is preferable that a filter used for the filtration device has an average pore diameter of 100 μm or less. Moreover, it is preferable that a filtration flow rate is 50 L/hr or more. The filtered dope 22 is sent to and pooled in a stock tank 21 of a film production line shown in FIG. 1.

By the way, when the swelling liquid is prepared and the dope is produced from the swelling liquid such as described above, it takes a longer time as a concentration of the TAC increases. Thus, a problem concerning production cost sometimes arises. In view of this, it is preferable that the dope is prepared so as to have a lower concentration relative to an intended concentration. In this case, a condensation process is performed to obtain the intended concentration after preparing the dope. When using this kind of the method, the dope filtered by the filtration device is sent to a flash device wherein the solvent of the dope is partially evaporated. Solvent gas generated due to the evaporation is condensed by a condenser (not shown) and becomes a liquid, which is recovered by a recovery device. The recovered solvent is recycled by a reproducing device as the solvent to be used for preparing the dope. This reuse is effective regarding the cost.

The condensed dope is extracted from the flash device by a pump. It is preferable that a defoaming process is performed to remove bubbles generated in the dope. As the method for removing the bubbles, various well-known methods are applicable. For instance, there is an ultrasonic irradiation method. The dope is sent to the filtration device to remove extraneous matter. Incidentally, at the time of filtration, it is preferable that a temperature of the dope is 0° C. to 200° C. Then the dope 22 is sent to the stock tank 21 and is pooled therein.

By the above method, the dope having the TAC concentration of 5% by mass to 40% by mass is produced. Much referable TAC concentration is 15% by mass or more and is 30% by mass or less. Most preferable TAC concentration is 17% by mass or more and is 25% by mass or less. Meanwhile, as to a concentration of the additive (mainly, plasticizer), it is preferable that a range thereof is 1% by mass or more and is 20% by mass or less when the entire solid contents of the dope is defined as 100% by mass. Regarding the dope producing method, Japanese Patent Application No. 2004-264464 teaches methods for dissolving and adding materials, raw materials and additives. This Application also teaches a filtrating method, a defoaming process and so forth. The description of this Application can be applied to the present invention.

[Solution Casting Method]

Next, is described a method for producing a film by using the obtained dope. FIG. 1 is a schematic illustration showing the film production line 20. The present invention, however, is not limited to the film production line shown in FIG. 1. The film production line 20 comprises the stock tank 21, a filtration device 30, a casting die 31, a belt 34 supported by rollers 32 and 33, and a tenter drier 35. The film production line 20 further comprises an edge slitting device 40, a drying chamber 41, a cooling chamber 42, and a winding chamber 43.

A stirrer 61 is attached to the stock tank 21 so as to be rotated by a motor 60. The stock tank 21 is connected to the casting die 31 via a pump 62 and the filtration device 30.

As to a material of the casting die 31, precipitation hardened stainless steel is preferable and it is preferable that a rate of thermal expansion thereof is 2×10⁵(° C.⁻¹) or less. It is possible to use a material having anti-corrosion properties, which is substantially equivalent with SU316 in corrosion examination of an electrolytic aqueous solution. Further, it is possible to use a material having anti-corrosion properties in which pitting is not caused at an air-liquid interface after dipped in a mixture liquid of dichloromethane, methanol and water for three months. Moreover, it is preferable to make the casting die 31 by grinding a material after at least one month has passed from foundry. In virtue of this, the dope 22 uniformly flows inside the casting die 31 and it is prevented that streaks are caused on a casting film 69 described later. As to finishing accuracy of a surface of the casting die 31, it is preferable that surface roughness is 1 μm or less and straightness is 1 μm/m or less in any direction. Slit clearance of the casting die 31 is adapted to be automatically adjusted within a range of 0.5 mm to 3.5 mm. With respect to a corner portion of a lip edge of the casting die 31, R thereof is adapted to be 50 μm or less in the entire width. Furthermore, it is preferable that a shear rate is adjusted so as to be 1 (1/sec) to 5000 (1/sec) at the inside of the casting die 31.

A width of the casting die 31 is not especially limited. However, it is preferable that the width thereof is 1.1 to 2.0 times a width of a film as a final product. Moreover, it is preferable that a temperature controller (not shown) is attached to the casting die 31 to maintain a predetermined temperature during film formation. Further, it is preferable to use the casting die 31 of a coat-hanger type. Furthermore, it is preferable that heat bolts for adjusting a thickness are disposed in a width direction of the casting die 31 at predetermined intervals and the casting die 31 is provided with an automatic thickness adjusting mechanism utilizing the heat bolts. In this case, the heat bolt sets a profile and forms a film along a preset program in accordance with a liquid amount sent by the pump (preferably, high-accuracy gear pump) 62. Feedback control may be performed along an adjustment program on the basis of a profile of a thickness gauge (infrared thickness gauge), which is disposed at the film production line 20 and is not shown. It is preferable that a thickness difference between any two points, which are located within an area excepting an edge portion and are positioned in a width direction of the film, is adjusted so as to be 1 μm or less. Regarding a minimum value and a maximum value of the thickness in the width direction, it is preferable that a difference between them is adjusted so as to be 3 μm or less, and it is much preferable that this difference is adjusted so as to be 2 μm or less. Further, it is preferable that thickness accuracy is adjusted so as to be ±1.5 μm or less.

Preferably, a hardened layer is formed on the lip edge of the casting die 31. A method for forming the hardened layer is not especially limited. There are ceramic coating, hard chrome-plating, nitriding treatment method and so forth. When the ceramic is utilized as the hardened layer, it is preferable that the ceramic has grindable property, low porosity, strength, excellent resistance to corrosion, excellent adhesiveness to the casting die 31, and non-adhesiveness to the dope 22. Concretely, there are tungsten carbide (WC), Al₂O₃, TiN, Cr₂O₃ and so forth. Among these, the WC is especially preferable. It is possible to perform WC coating by a spraying method.

It is preferable that a solvent supplying device (not shown) is attached to a slit end of the casting die 31 in order to prevent the dope, which flows out to the slit end, from being partially dried and solidified. In this case, it is preferable to supply a solvent (for example, mixed solvent of dichloromethane 86.5 pts.wt, acetone 13 pts.wt and n-butanol 0.5 pts.wt), which is capable of dissolving the dope, to a peripheral portion of three-phase contact lines formed by both end portions of a casting bead, an end portion of a die slit, and ambient air. In order to prevent extraneous matter from entering the casting film, it is preferable to supply the solvent to each side of the end portions at a rate of 00.1 mL/min to 1.00 mL/min. Incidentally, as a pump for supplying this liquid, it is preferable to use the one having a pulsation rate of 50% or less.

The belt 34 supported by the rollers 32 and 33 is disposed under the casting die 31. The rollers 32 and 33 are rotated by a driving device not shown. In association with the rotation of these rollers, the belt 34 runs in an endless manner. It is preferable that a movement speed of the belt 34, or casting speed is 10 m/minute or more and is 200 m/minute or less. It is much preferable that the casting speed is 15 m/minute or more and is 150 m/minute or less, and it is most preferable that the casting speed is 20 m/minute or more and is 120 m/minute or less. When the casting speed is less than 10 m/minute, productivity of the film deteriorates. In contrast, when the casting speed exceeds 200 m/minute, constant formation of beads is prevented and a surface condition of the casting film 69 is likely to deteriorate.

In order to keep a surface temperature of the belt 34 at a predetermined value, it is preferable that a heat transfer medium circulator 63 is attached to the rollers 32 and 33. It is preferable that the surface temperature of the belt 34 is adjustable within a range of −20° C. to 40° C. A passage (not shown) for the heat transfer medium is formed in the respective rollers 32 and 33 used in this embodiment. The heat transfer medium maintained at a predetermined temperature passes through the inside of the passage to keep a temperature of the respective rollers 32 and 33 at a predetermined value.

A width of the belt 34 is not especially limited. However, it is preferable that the width of the belt 34 is 1.1 to 2.0 times the casting width of the dope 22. Preferably, a length of the belt 34 is 20 m to 200 m, and a thickness thereof is 0.5 mm to 2.5 mm. It is preferable that the belt 34 is ground so as to have surface roughness of 0.05 μm or less. Preferably, the belt 34 is made of stainless steel, and it is much preferable that the belt 34 is made of SUS316 so as to have sufficient corrosion resistance and strength. Moreover, it is preferable that thickness unevenness of the entire belt 34 is 0.5% or less.

In the meantime, the rollers 32 and 33 may be used as a direct support. In this case, it is preferable that the rollers are capable of accurately rotating with rotational unevenness of 0.2 mm or less. Further, it is preferable that the rollers 32 and 33 have average surface roughness of 0.01 μm or less. The surface of the roller is chromeplated so as to have sufficient hardness and durability. Incidentally, it is necessary to minimize surface defect of the support (belt 34 and rollers 32 and 33). Concretely, it is preferable that there is no pinhole of 30 cm or more, and a number of the pinholes of 10 μm or more and 30 μm or less is at least one per square meter, and a number of the pinhole of 10 μm or less is at least 2 per square meter.

The casting die 31, the belt 34 and so forth are contained in a casting chamber 64 provided with a temperature regulator 65 for maintaining an inside temperature thereof at a predetermined value. The casting chamber 64 is further provided with a condenser 66 for condensing and recovering vaporizing organic solvent. A recovery device 67 for recovering the condensed and devolatilized organic solvent is disposed at the outside of the casting chamber 64. It is preferable to dispose a decompression chamber 68 for controlling a pressure of a rear portion of the casting bead formed between the casting die 31 and the belt 34.

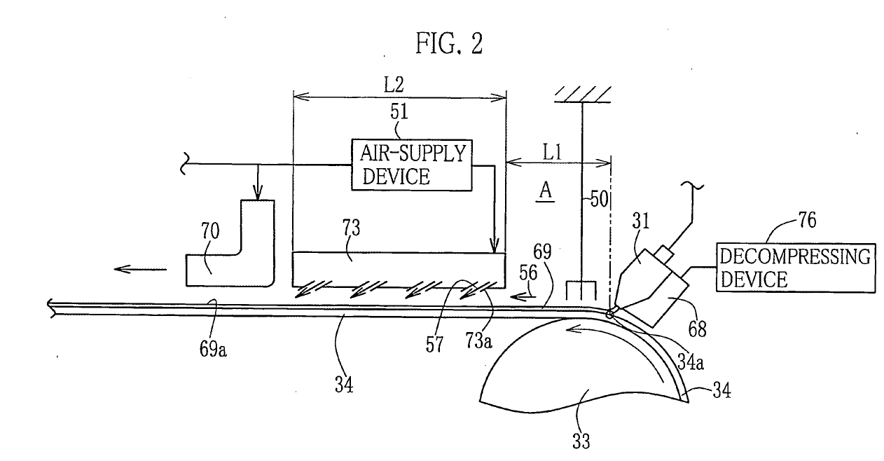

Blower units 70, 71 and 72 for vaporizing the solvent of the casting film 69 are disposed near a peripheral surface of the belt 34. In addition, such as shown in FIG. 2, a labyrinth seal 50 is disposed near the casting die 31 in order to control planar waves of the casting film 69 to be caused by dry air blowing to the casting film 69 just after casting. Further, another blower unit 73 for rapid drying is disposed between the labyrinth seal 50 and the blower unit 70. An air-supply device 51 is connected to the rapid-drying blower unit 73 and the other blower units 70 to 72. The rapid-drying blower unit 73 has a plurality of nozzles 73a, and dry air 57 is applied to the surface of the casting film 69 to form an initial film 69a thereon. In FIG. 2, the rapid-drying blower unit 73 is provided with four nozzles. The present invention, however, is not limited to this. A distance between the rapid-drying blower unit 73 and a casting start position is represented by L1 (mm), and an area thereof is referred to as a natural air area A. A length of the rapid-drying, blower unit 73 is represented by L2 (mm). Meanwhile, a decompressing device (for instance, a root-type blower) 76 is connected to the decompression chamber 68. Incidentally, it is preferable that the dry air 57 is applied to the casting film 69 for 20 seconds or more. When the period for applying the dry air 57 is less than 20 seconds, the formation of the initial film 69a is likely to be disturbed. In this case, there is a possibility that the film having excellent surface conditions can not be obtained.

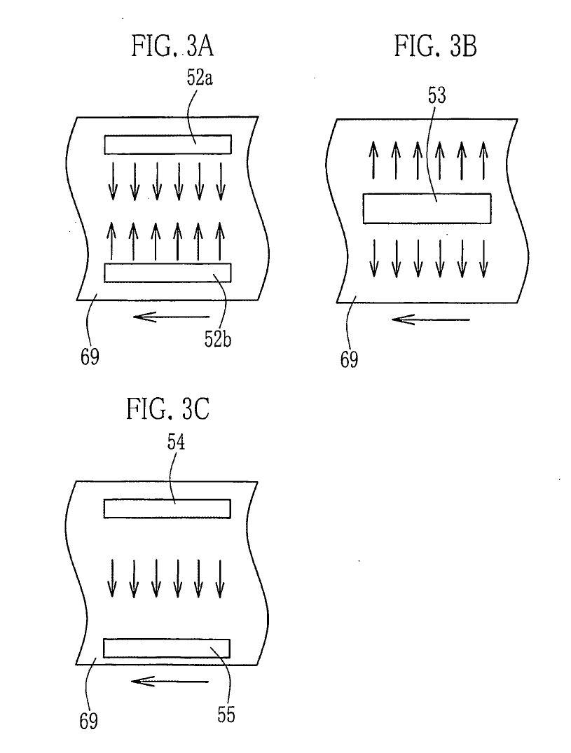

As shown in FIGS. 3A, 3B and 3C, it is possible to adopt various manners concerning a blower direction of the dry air blowing from the nozzles. In FIG. 3A, the dry air is applied to a central portion of the casting film 69 from the nozzles 52a and 52b disposed at both sides of the casting film 69. In FIG. 3B, the nozzle 53 is disposed at the center of the casting film 69 in a width direction thereof, and the dry air is applied from the central portion to both sides. In FIG. 3C, the dry air is applied to the casting film 69 in a state that the dry air flows from the nozzle 54 toward an aspirator 55. By the way, the nozzle may have any shape.

A transporting section 80 is provided with an air blower 81. The edge slitting device 40, which is disposed at a downstream side of the tenter drier 35, is connected to a crusher 90 for shredding side edges cut from the film 82.

The drying chamber 41 is provided with many rollers 91. An absorbing device 92 is attached to the drying chamber 41 to absorb and recover solvent gas generated due to evaporation. In FIG. 1, the cooling chamber 42 is disposed at a downstream side of the drying chamber 41. However, a humidity-controlling chamber (not shown) may be disposed between the drying chamber 41 and the cooling chamber 42. At a downstream side of the cooling device 42, a neutralization device (neutralization bar) 93 is disposed to regulate a charged voltage of the film 82 within a predetermined range (for example, −3 kV to +3 kV). Although the neutralization device 93 is disposed at the downstream side of the cooling device 42 in FIG. 1, this setting position is not exclusive. In this embodiment, a knurling roller 94 is properly disposed at a downstream side of the neutralization device 93 to form knurling on both edges of the film 82 by emboss processing. Further, the inside of the winding chamber 43 is provided with a winding roller 95 for winding the film 82, and a press roller 96 for controlling tension at the time of winding.

Next, is described an embodiment of a method for producing the film 82 by using the above-described film production line 20. The dope 22 is always uniformed by the rotation of the stirrer 61. Additive of plasticizer, UV-absorbing agents and so forth may be mixed in the dope 22 during the stir.

The dope 22 is sent to the filtration device 30 by the pump 62 and is filtered therein. After that, the dope 22 is applied onto the belt 34 from the casting die 31. It is preferable that the rollers 32 and 33 are driven so as to adjust the tension of the belt 34 to 10⁴N/m to 10⁵N/m. Moreover, a relative speed difference between the belt 34 and the rollers 32 and 33 are adjusted so as to be 0.01 m/min or less. Preferably, speed fluctuation of the belt 34 is 0.5% or less, and meandering thereof caused in a width direction is 1.5 mm or less while the belt 34 makes one rotation. In order to control the meandering, it is preferable that a detector (not shown) is provided to detect the positions of both sides of the belt 34. On the basis of a measurement value of the detector, feedback control is performed for a position controller (not shown) of the belt 34 to adjust the position thereof. With respect to a portion of the belt 34 located just under the casting die 31, it is preferable that vertical positional fluctuation caused in association with the rotation of the roller 33 is adjusted so as to be 200 μm or less. Further, it is preferable that the temperature of the casting chamber 64 is adjusted within a range of −10° C. to 57° C. by the temperature regulator 65. Incidentally, the solvent vaporized inside the casting chamber 64 is recycled as dope preparing solvent after being collected by the recovery device 67.

The casting bead is formed between the casting die 31 and the belt 34, and the casting film 69 is formed on the belt 34. It is preferable that the temperature of the dope 22 is −10° C. to 57° C. at the time of casting. In order to stabilize the casting bead, it is preferable that the rear of the casting bead is controlled by the decompression chamber 68 so as to be set to a desired pressure value. Preferably, the rear of the bead is decompressed within a range of −2000 Pa to −10 Pa relative to the front thereof. Moreover, it is preferable that a jacket (not shown) is attached to the decompression chamber 68 to maintain the inside temperature at a predetermined temperature. Although the temperature of the decompression chamber 68 is not especially limited, it is preferable to set this temperature at least a condensation point of the organic solvent. Further, it is preferable that a suction unit (not shown) is attached to an edge portion of the casting die 31 in order to keep a desired shape of the casting bead. A preferable range of an air amount for aspirating the edge is 1 L/min to 100 L/min.

The dope 22 flows from the casting die 31 onto the belt 34, forming the casing bead. At the time of casting, preferable viscosity (measured by rheometer) of the dope 22 is 10 Pa·s or more and 100 Pa·s or less. Much preferable viscosity is 12 Pa·s or more and 50 Pa·s or less, and most preferable viscosity is 15 Pa·s or more and 40 Pa·s or less. The casting bead forms the casting film 69 on the belt 34. Incidentally, a position where the casting bead reaches the belt 34 is referred to as the casting start position 34a. When the viscosity of the dope 22 is less than 10 Pa·s, the viscosity is too low and the dry air is likely to cause unevenness. Due to this, the surface conditions of the casting film 69 deteriorate, and sometimes it is difficult to form the initial film 69a. Further, since a content of solvent is high, the solvent drastically vaporizes at an initial stage of drying the casting film 69. Due to this, drying defect (for instance, foaming) is likely to be caused, and it may be required to enlarge the equipment for recovering the solvent.

The casting film 69 moves in association with the movement of the belt 34. Natural air occurs above the casting film 69. In the natural air area A, the labyrinth seal 50 is disposed to prevent the natural air 56 from flowing back toward the casting die 31. The natural air 56 is usually a weak air having a velocity of 2 m/s or less. However, if the natural air 56 roughly flowing is applied to the surface of the casting film 69, the surface conditions thereof deteriorate. In view of this, it is preferable that the length L1 (mm) of the natural air area A is shorter as much as possible. However, in consideration of relational arrangement positions of the respective units constituting the film production line 20, there is no problem if the length L1 (mm) is 3000 mm or less. Much preferable length L1 is 2000 mm or less, and especially preferable length L1 is 1000 mm or less. Meanwhile, it is preferable that the casting film 69 passes through the natural air area A within 15 seconds. Much preferable transit time is 10 seconds or less, and especially preferable transit time is 7 seconds or less.

Successively, the casting film 69 is continuously carried to the place where the rapid-drying blower unit 73 is disposed at the upper portion. The dry air 57 is sent from the nozzle 73a of the blower unit 73 toward the casting film 69. Upon applying the dry air to the casting film 69, the initial film 69a is formed on the surface of the casting film 69. This surface is smoothed by leveling effect of the initial film 69a, and then is dried. In the present invention, the method for forming the initial film 69 is not limited to the application of the dry air 57. For example, the initial film 69a may be formed by infrared heating, microwave heating and so forth.

Preferable velocity of the dry air 57 is 3 m/s or more and 20 m/s or less. Much preferable velocity is 3 m/s or more and 15 m/s or less, and much more preferable velocity is 4 m/s or more and 12 m/s or less. Most preferable velocity is 4 m/s or more and 10 m/s or less. When the velocity of the dry air is less than 3 m/s, the initial film 69a is slowly formed and the surface conditions of the casting film 69 is likely to deteriorate before forming the initial film. In contrast, when the velocity of the dry air exceeds 20 m/s, the dry air 57 is too strongly applied to the casting film 69. Thus, there is a possibility that the initial film 69a having excellent surface conditions is not formed.

Preferable gas concentration of the dry air 57 is 25% or less. Much preferable gas concentration is 20% or less, and most preferable gas concentration is 18% or less. In the present invention, the gas concentration means evaporated solvent of the dry air 57 measured by an infrared analyzing method. The casting film 69 includes a great deal of solvent just after the formation thereof. When the gas concentration of the dry air 57 exceeds 25%, the solvent is slowly evaporated from the casting film 69 and sometimes it is difficult to form the initial film 69a.

Preferable temperature of the dry air is 40° C. or more and 120° C. or less. Much preferable temperature is 45° C. or more and 110° C. or less, and most preferable temperature is 50° C. or more and 100° C. or less. When the temperature is less than 40° C., the solvent is hardly evaporated from the casting film 69. Thus, there is a possibility that it is difficult to form the initial film 69a having a good film surface. In contrast, when the temperature exceeds 120° C., the solvent of the casting film 69 is likely to foam and rapidly evaporate. In this case, there is a possibility that it is difficult to form the initial film 69a having good surface conditions.

In the present invention, a preferred period for applying the natural air 56 to the casting film 69 is 15 seconds or less after casting. Much preferable period is 10 seconds or less, and most preferable period is 7 seconds or less. When the period for applying the natural air 56 to the casting film 69 exceeds 15 seconds, it is prevented to perform rapid drying. Due to this, thickness unevenness is caused on the surface of the casting film 69 before forming the uniform initial film 69a on the surface of the casting film 69. Thus, it is impossible to obtain the film 82 having uniform surface conditions. Moreover, since the drying time becomes long, productivity of the film 82 deteriorates.

Preferable solvent content of the casting film 69 is 300% by mass or more and 500% by mass or less at a time of peeling. Much preferable solvent content is 320% by mass or more and 450% by mass or less, and most preferable solvent content is 350% by mass or more and 420% by mass or less. If the solvent content is less than 300% by mass, defect of rupture or the like is sometimes caused in a wet film 74 when stretching relaxation and so forth are performed in a succeeding process after peeling the wet film 74 from the belt 34. In contrast, if the solvent content exceeds 500% by mass, mechanical strength is likely to lack and it takes time for drying the wet film 74.

It is preferable that a diminution rate of the remaining solvent of the casting film 69 is 1% by mass per second or more and 12% by mass per second or less when 30 seconds have passed after sending the dry air 57 to the casting film 69. Much preferable diminution rate is 3% by mass per second or more and 11% by mass per second or less, and most preferable diminution rate is 5% by mass per second or more and 10% by mass per second or less. When the drying rate is less than 1% by mass per second, the initial film 69a is slowly formed and there is a possibility that it is difficult to form the initial film 69a having sufficient film-face strength. In contrast, when the drying rate exceeds 12% by mass per second, the initial film 69a is likely to be nonuniformly formed and foaming is likely to occur in the casting film 69. Further, there is a possibility that surf ace conditions of the film deteriorate.

The casting film 69 moves in association with the movement of the belt 34. At this time, the dry air is applied to the casting film 69 by the blower units 70, 71 and 72 to facilitate the vaporization of the solvent. Due to blowing of the dry air, the surface conditions of the casting film 69 sometimes fluctuate. However, the labyrinth seal 50 prevents this fluctuation. Incidentally, preferable surface temperature of the belt 34 is −20° C. to 40° C.

After the casting film 69 has possessed a self-supporting property, this film 69 is peeled from the belt 34 as the wet film 74 while supported by a peeling roller 75. At the time of peeling, it is preferable that a remaining solvent amount is 20% by mass to 250% by mass on a solid basis. After that, the wet film 74 is carried along the transporting section 80 provided with the many rollers, and then the wet film 74 is fed into the tenter drier 35. In the transporting section 80, dry air of a desired temperature is sent from the air blower 81 to facilitate a drying process of the wet film 74. At this time, it is preferable that the temperature of the dry air is 20° C. to 250° C. In the transporting section 80, it is possible to give a draw tension to the wet film 74 by increasing a rotation speed of the downstream roller in comparison with that of the upstream roller.

The wet film 74 fed into the tenter drier 35 is dried while carried in a state that both sides thereof are held with clips. It is preferable that the inside of the tenter drier 35 is divided into temperature zones and drying conditions are properly adjusted in each zone. The wet film 74 may be stretched in a width direction by using the tenter drier 35. It is preferable that the wet film 74 is stretched in the transporting section 80 and/or the tenter drier 35 by 0.5% to 300% with respect to either of the casting direction and the width direction.

The wet film 74 is dried by the tenter drier 35 until the remaining solvent amount reaches a predetermined value. After that, the wet film 74 is sent toward a downstream side as the film 82. Both edges of the film 82 are cut off by the edge slitting device 40. The cut edges are sent to the crusher 90 by a cutter blower not shown. The film edges are shredded by the crusher 90 and become chips. Since the chip is recycled for preparing the dope, this method has an advantage regarding the cost. The slitting process for the film edges may be omitted. However, it is preferable to perform the slitting process between the casting process and the film winding process.

The film 82 of which both edges have been cut off is sent to the drying chamber 41 and is further dried. Although a temperature of the drying chamber 41 is not especially limited, a preferable range of the temperature is 50° C. to 160° C. In the drying chamber 41, the film 82 is carried so as to move around the rollers 91, and the solvent gas vaporized therein is absorbed and recovered by the absorbing device 92. The air from which the solvent ingredient is removed is sent again into the drying chamber 41 as the dry air. Incidentally, it is preferable that the drying chamber 41 is divided into a plurality of regions for the purpose of changing the drying temperature. Meanwhile, in a case that a preliminary drying chamber (not shown) is provided between the edge slitting device 40 and the drying chamber 41 to preliminarily dry the film 82, a film temperature is prevented from rapidly increasing in the drying chamber 41. Thus, in this case, it is possible to prevent a shape of the film 82 from changing.

The film 82 is cooled in the cooling chamber 42 until the film temperature substantially becomes a room temperature. A temperature adjusting chamber (not shown) may be provided between the drying chamber 41 and the cooling chamber 42. Preferably, air having desirable humidity and temperature is applied to the film 82 in the temperature adjusting chamber. By doing so, it is possible to prevent the film 82 from curling and to prevent winding defect from occurring at the time of winding.

In the meantime, while the film 82 is carried, the charged voltage thereof is kept in a predetermined range (for example, −3 kV to +3 kV) by the neutralization device (neutralization bar) 93, which is disposed at a downstream side of the cooling chamber 42 in FIG. 1, but this position is not exclusive. Further, it is preferable that the knurling roller 94 is provided to form the knurling on both edges of the film 82 by the emboss processing. Incidentally, it is preferable that asperity of the knurling portion is 1 μm to 200 μm.

Finally, the film 82 is wound up by the winding roller 95 contained in the winding chamber 43. At this time, it is preferable to wind the film 82 in a state that a desirable tension is given by the press roller 96. Preferably, the tension is gradually changed from the start of winding to the end thereof. It is preferable that a length of the film 82 to be wound up is at least 100 m in a longitudinal direction (casting direction). A preferable width of the film 82 is 600 mm or more, and a much preferable width thereof is 1400 mm or more and 1800 mm or less. The present invention, however, is also effective in case the width is more than 1800 mm. The present invention is applicable to a case in that a thin film of which thickness is 15 μm or more and 100 μm or less is produced.

The solution casting method of the present invention may be a co-casting method in which a co-casting of two or more sorts of the dopes are made such that the dopes may form a multi-layer film, or a sequentially casting method in which two or more sorts of the dopes are sequentially cast so as to form the multi-layer film. Further, both of these methods may be combined. When the co-casting is performed, a feed block may be attached to the casting die, or a multi-manifold type casting die may be used. A thickness of each upper and lowermost layer of the multi-layer casting film on the support is preferably in the range of 0.5% to 30% to the total thickness of the multi-layer casting film. Furthermore, in the co-casting method, when the dope is cast onto the support, it is preferable that the lower viscosity dopes may entirely cover over the higher viscosity dope. Furthermore, in the co-casing method, it is preferable that the inner dope is covered with dopes whose alcohol contents are larger in the bead from a die to the support.

Note that Japanese Patent Application No. 2004-264464 teaches in detail the structure of the casting die, the decompression chamber and the support, drying conditions in the respective processes of co-casting, peeling and stretching, a handling method, a winding method after the correction of planarity and curling, a recovering method of the solvent, a recovering method of film and the like. The description of the above application may be applied to the present invention.

[Characteristics, Measuring Method]

(Degree of Curl, Thickness)

The above-noted application No. 2004-264464 teaches the characteristics and the measuring method of the cellulose acylate film, which may be applied to the present invention.

[Surface Treatment]

It is preferable to make a surface treatment of at least one surface of the cellulose acylate film. Preferably, the surface treatment is at least one of glow discharge treatment, atmospheric pressure plasma discharge treatment, UV radiation treatment, corona discharge treatment, flame treatment, and acid or alkali treatment.

[Functional Layer]

(Prevention of Static Charge, Hardening Layer, Antireflection, Easy Adhesion, Antiglare)

A primary coating may be made over at least one surface of the cellulose acylate film.

Further, it is preferable to provide other functional layers for the cellulose acylate film as a film base so as to obtain a functional material. The functional layers may be at least one of antistatic layer, hardening resin layer, antireflection layer, adhesive layer for easy adhesion, antiglare layer and an optical compensation layer.

Preferably, the functional layer contains at least one sort of surface active agent in the range of 0.1 mg/m² to 1000 mg/m². Further, preferably, the functional layer contains at least one sort of lubricant in the range of 0.1 mg/m² to 1000 mg/m². Further, preferably, the functional layer contains at least one sort of matting agent in the range of 0.1 mg/m² to 1000 mg/m². Further, preferably, the functional layer contains at least one sort of antistatic agent in the range of 1 mg/m² to 1000 mg/m². Conditions and methods of performing a surface treatment and providing a functional layer with several functions and characteristics are described in Japanese Patent Application No. 2004-264464. These descriptions may be applied to the present invention.

(Application)

The cellulose acylate film can be used as the protective film in a polarizing filter. To obtain a LCD, two polarizing filters, in each of which the cellulose acylate film is adhered to polarizer, are disposed so as to sandwich a liquid-crystal layer. Arrangement of the liquid-crystal layer and the polarizing filters is not limited, and well-known various kinds of arrangement may be adopted. The application No. 2004-264464 discloses TN type, STN type, VA type, OCB type, reflection type, and other example in detail. To these types can be applied the film of the present invention. Further, the application teaches the cellulose acylate film provided with an optical anisotropic layer and that provided with antireflective and antiglare functions. Furthermore, the application supposes to provide the cellulose acylate film with adequate optical functions, and thus a biaxial cellulose acylate film is obtained and used as the optical compensation film, which can be used as the protective film in the polarizing filter simultaneously. The restriction thereof described in the application No. 2004-264464 can be applied to the present invention.

By the producing method of the present invention, it is possible to obtain a cellulose triacetate film (TAC film) having excellent optical properties. The TAC film is used as the protective film for the polarizing filter, and is also used as a base film of photosensitive material. Further, the TAC film may be used as an optical compensation film for improving a dependence property of a view angle of a liquid-crystal display to be employed in a television and so forth. Especially, the TAC film is effective when also used as a protective layer of the polarizing filter. Thus, the TAC film is used for not only conventional TN mode but also IPS mode, OCB mode, VA mode and so forth. The protective film for the polarizing filter may be utilized to constitute the polarizing filter.

### EXAMPLE 1

Hereinafter, the present invention is described with Example 1. However, the present invention is not limited to Example 1. In the following, Experiment 1 according to the present invention is described in detail. With respect to Experiment 2 of the present invention and Experiments 3 and 4 being as comparative examples, experimental conditions and results thereof are collectively shown in Table 1.

[Experiment 1]

Experiments of the present invention are described below. As to the polymer solution (dope) used for producing the film, composition thereof at the time of preparing the dope is shown below.

[Composition]

| | | |
|---|---|---|
| Cellulose Triacetate (powder in which substitution | 100 | pts. wt |
| degree was 2.84, viscosity average degree of | | |
| polymerization was 306, moisture content was 0.2% | | |
| by mass, viscosity of solution of 6% by mass | | |
| dichloromethane was 315 mPa · s, average particle | | |
| diameter was 1.5 mm, and standard deviation thereof | | |
| was 0.5 mm) | | |
| Dichloromethane (first solvent) | 320 | pts. wt |
| Methanol (second solvent) | 83 | pts. wt |
| 1-butanol (third solvent) | 3 | pts. wt |
| Plasticizer A (triphenyl phosphate) | 7.6 | pts. wt |
| Plasticizer B (diphenyl phosphate) | 3.8 | pts. wt |
| UV agent a: 2(2′-hydroxyl-3′,5′-di-tert-butylphenyl) | 0.7 | pts. wt |
| benzotriazole | | |
| UV agent b: 2(2′-hydroxyl-3′,5′-di-tert-alumiphenyl)-5- | 0.3 | pts. wt |
| chlorbenzotriazole | | |
| Citrate ester mixture (citric acid, monoethyl ester, | 0.006 | pts. wt |
| diethyl ester, triethyl ester mixture) | | |
| Fine Particle (silicon dioxide (of which average particle | 0.05 | pts. wt |
| diameter was 15 nm), Mohs hardness was about 7) | | |

[Cellulose Triacetate]

As to the used cellulose triacetate, remaining acetic acid did not exceed 0.1% by mass, Ca content was 58 ppm, Mg content was 42 ppm, and Fe content was 0.5 ppm. The cellulose triacetate included releasing acetic acid 40 ppm and sulfate ion 15 ppm. Moreover, the degree of substitution for the acetyl group at the sixth position was 0.91. In 32.5% of the whole acetyl group, the sixth position of hydroxyl was substituted. Acetone extraction amount was 8% by mass, and a ratio of weight-average molecular weight to number average molecular weight was 2.5. Yellow index of the obtained TAC was 1.7, and haze was 0.08. Transparency was 93.5%, and Tg (glass-transition temperature measure by DSC) was 160° C. Crystallization calorific value was 6.4 J/g. The TAC was synthesized from cellulose which was taken from cotton.

Hereinafter, this TAC is referred to as cotton-source TAC.

(1-1) Dope Feed

In a stainless dissolution tank of 4000 L with stirrer blades, the above-mentioned solvents were mixed and stirred to obtain a mixed solvent. With respect to each raw material of the solvents, water content thereof was 0.5% by mass or less. Successively, flake powder of the TAC was gradually added from a hopper. The TAC powder was put into the dissolution tank and was dispersed for thirty minutes under condition that stirring was performed with a decentering stirrer of dissolver type, whose peripheral velocity was 5 m/sec at first, and a stirrer having a central anchor blade, whose peripheral velocity was 1 m/sec. A temperature was 25° C. at the start of dispersion and the final temperature was 48° C. Further, additive solution, which was prepared in advance, was sent so as to make the entire weight 2000 Kg. After terminating the dispersion of the additive solution, the high-speed stir was stopped. Successively, the peripheral velocity of the anchor blade was set to 0.5 m/sec and the stir was further performed for 100 minutes to obtain a swelling liquid in which the TAC flake was swelled. Until a termination of swelling, the inside of the dissolution tank was pressurized by nitrogen gas so as to be kept at 0.12 MPa. At this time, the internal oxygen concentration of the dissolution tank was less than 2 vol % so that problem-free conditions were maintained regarding dustproof. Meanwhile, moisture content of the swelling liquid was 0.3% by mass.

(1-2) Dissolution and Filtration

The swelling liquid was sent to piping provided with a dissolution-tank jacket and was heated up to 50° C. therein. Further, the swelling liquid was heated up to 90° C. under pressurization of 2 MPa and was completely dissolved. At this time, the heating period was 15 minutes. Then, the temperature of the dissolved liquid was lowered by a temperature controller to 36%, and the dissolved liquid passed through a filtration device having filter elements, a nominal pore diameter of which was 8 am, to prepare the dope (herein after, this dope is referred to as unconcentration dope). At this time, primary pressure of the filtration device was 1.5 MPa and secondary pressure thereof was 1.2 MPa. Hastelloy (trade name) alloy having excellent corrosion resistance was utilized for a filter, housing and the piping to which high temperature was applied. Moreover, was provided a jacket through which heat transfer media for insulating and heating passed.

(1-3) Concentration, Filtration, Defoaming and Additive

The unconcentration dope obtained in this way was flash-vaporized in a flash device having a normal pressure at 80° C., and the vaporized solvent was recovered by a condenser. Solid content concentration of the dope 22 was 21.8% by mass after the flash. The condensed solvent was recovered by the recovery device in order to be recycled as the dope preparing solvent. The recovered solvent was reprocessed by a reprocessing device and was sent to the solvent tank. In the recovery device and the reprocessing device, distillation and dehydration were performed. A flash tank of the flash device was provided with a stirrer (not shown) comprising an anchor blade attached to a stirring shaft. The stirrer agitated the dope 22, which was flashed at a peripheral velocity of 0.5 m/s, to perform defoaming. Temperature of the dope 22 contained in the flash tank was 25° C., and an average retaining period of the dope 22 in the tank was 50 minutes. The dope 22 was taken to measure a shear viscosity at 25° C. The measured shear viscosity was 450 Pa·s at a shear rate of 10 (sec⁻).

Successively, weak ultrasonic waves were applied to the dope 22 to remove the foam. After that, the dope 22 passed through the filtration device in a state pressurized up to 1.5 MPa by a pump. In the filtration device, the dope firstly passed through a sintered fiber metal filter having a nominal pore diameter of 10 μm. And then, the dope passed through a sintered fiber filter having the same nominal pore diameter of 10 μm. Primary pressures of the respective filters were 1.5 MPa and 1.2 MPa, and secondary pressures thereof were 1.0 MPa and 0.8 MPa. After the filtration, the temperature of the dope was adjusted to 36° C., and the dope was sent to the stainless stock tank 21 of 2000 L for storage. The stock tank 21 included the stirrer 61 provided with the anchor blade, which is attached to the central shaft. The stir was constantly performed at the peripheral velocity of 0.3 m/sec. Incidentally, when the dope was prepared from the unconcentration dope, problems of corrosion and so forth hardly occur in a dope contact portion.

Also, was produced a mixed solvent A having dichloromethane of 86.5 pts.wt, acetone of 13 pts.wt and 1-butanol of 0.5 pts.wt.

(1-4) Discharge, Immediately Proceeding Addition, Casting, Bead Decompression

The film 82 was produced by using the film production line 20 shown in FIG. 1. The dope 22 contained in the stock tank 21 was sent to the filtration device 30 by the high-accuracy gear pump 62. The gear pump 62 has a function for increasing the primary pressure thereof, and the feedback control was performed for the upstream side of the pump 62 by an inverter motor so as to make the primary pressure 0.8 MPa. As to the performance of the used gear pump 62, volume efficiency was 99.2% and a fluctuation rate of the discharge amount was 0.5% or less. Moreover, discharge pressure was 1.5 MPa. The dope 22 passed through the filtration device 30 and was sent to the casting die 31.

The casting die 31 performed casting so as to make the width and the thickness of the dried film 1.8 m and 80 μm respectively, adjusting the flow rate of the dope 22 at a discharge port of the casting die 31. At this time, the viscosity of the dope 22 was 20 Pa·s. Moreover, a casting width of the dope 22 discharged from the casting die 31 was 1700 mm. Incidentally, a casting speed was 20 m/min. For the purpose of adjusting the temperature of the dope 22 to 36° C., the casting die 31 was provided with a jacket (not shown), and an inlet temperature of heat transfer media to be supplied to the jacket was set to 36° C.

The casting die 31 and the piping were wholly kept at 36° C. during the formation of the film. The casting die 31 of the coat hanger type was used. The used casting die 31 was provided with thickness adjusting bolts disposed at 20 mm intervals and was provided with an automatic thickness adjusting mechanism utilizing heat bolts. The heat bolt was capable of setting a profile by a preset program in accordance with an amount sent by the gear pump 62. Further, the used heat bolt was capable of performing the feedback control by an adjustment program based on a profile of an infrared-ray thickness gauge disposed at the film production line 20. As to the film except for its edge portion of 20 mm, adjustment was performed such that thickness difference was 1 μm or less concerning any two points separated by 50 mm, and such that thickness fluctuation was 39 m/m or less in the width direction. Further, the entire thickness was adjusted so as to be ±1.5% or less.

In the primary side of the casting die 31, the decompression chamber 68 was provided to depressurize this portion. The decompression chamber 68 was adjusted so as to cause pressure difference of 1 Pa to 5000 Pa relative to the front and the rear of the casting bead. This adjustment was performed in accordance with the casting speed. At this time, pressure difference of both sides of the casting bead was set so as to make the length of the casting bead 20 mm to 50 mm. The used decompression chamber 68 was provided with a mechanism, which was capable of setting a higher temperature in comparison with a concentration temperature of a gas surrounding the casting portion. The labyrinth seal 50 (see FIG. 2) was disposed in front of the bead discharged from the discharge port of the casting die. Both ends of the discharge port were provided with openings, and an edge suctioning device (not shown) was attached to the casting die 31 to regulate disarray of both ends of the casting bead.

(1-5) Casting Die

Material of the casting die 31 was the precipitation hardened stainless steel having a thermal expansion rate of 2×10⁻⁵ (° C.⁻¹) or less. This material possessed corrosion resistance identical with that of a material made of SUS316, as a result of a compulsory corrosion examination performed in an electrolyte aqueous solution. Further, as a result of dipping this material in a mixed solution of dichloromethane, methanol and water for three months, pitting was not caused at a gas-liquid interface. As to finishing accuracy of the dope contact surface of the casting die 31, the surface roughness was 1 μm or less, the straightness was 1 μm/m or less in any direction, and the clearance of the slit was 1.5 mm. With respect to a corner of the dope contact portion located at the lip of the casting die 31, R was 50 cm or less on the entire width of the slit. The shear rate of the dope 22 contained in the casting die 31 was 1 (1/sec) to 5000 (1/sec). Meanwhile, WC (tungsten carbide) coating was performed by a spraying method to form a hardened layer on the lip of the casting die 31.

In order to prevent the effluent dope 22 from partially drying and becoming solidified, the mixed solvent A for dissolving the dope 22 was supplied to the discharge port of the casting die 31 by 0.5 ml per minute. The mixed solvent was supplied to interfaces defined by both sides of the casting bead and the discharge port. A pulsation rate of a pump supplying the mixed solvent was 5% or less. The rear-side pressure of the casting bead was lowered by 150 Pa with the decompression chamber 68 in comparison with the front-side pressure thereof. A jacket (not shown) was attached for the purpose of keeping the inside temperature of the decompression chamber 68 at a predetermined constant temperature. Heat transfer media adjusted to 35° C. were supplied into the jacket. The edge suctioning device was capable of adjusting an air amount for suctioning the edge within a range of 1 L/min to 100 L/min. In this example, this air amount was properly adjusted within a range of 30 L/min to 40 L/min.

(1-6) Metal Support

As to the support, a stainless-steel endless belt having a width of 2.1 m and a length of 70 m was utilized as the belt 34. This belt 34 was polished so as to make its thickness 1.5 mm and so as to make its surface roughness 0.05 μm or less. Material of the belt 34 was SUS316, and the belt 34 possessed sufficient corrosion resistance and strength. Thickness unevenness of the entire belt 34 was 0.5% or less. The belt 34 was driven by the two rollers 32 and 33. When the belt 34 was driven, tension thereof was adjusted so as to be 1.5×10⁵N/m² in the carrying direction. In addition, relative velocity difference between the belt 34 and the rollers 32, 33 was adjusted so as to be 0.01 m/min or less. At this time, velocity fluctuation of the belt was 0.5% or less. Both end positions of the belt 34 was detected and controlled so as to restrict meandering within a range of 1.5 mm or less in the width direction during one rotation. Vertical positional fluctuation of the die lip and the belt 34 was 200 μm or less under the casting die 31. The belt 34 was disposed in the casting chamber 64 provided with an air-pressure control unit (not shown). The dope 22 was cast from the casting die 31 onto the belt 34.

The used rollers 32 and 33 were capable of letting heat transfer media pass through the inside thereof so that the temperature of the belt 34 was adjusted. The heat transfer media of 5° C. flowed in the roller 33 disposed near the casting die 31, and the heat transfer media of 40° C. flowed in the other roller 32 for the purpose of drying. A central surface temperature of the belt 34 was 15° C. just before casting, and a temperature difference between both sides thereof was 6° C. or less. By the way, it is preferable that the belt 34 has no defect on its surface. In view of this, the used belt 34 had no pinhole of 30 cm or more. A number of the pinholes of 10 μm to 30 μm was 1/m² or less, and a number of the pinholes which is less than 10 μm was 2/m² or less.

(1-7) Casting and Drying

The temperature of the casting chamber 64 was maintained at 35° C. by using the temperature regulator 65. The dope 22 was cast onto the belt 34 to form the casting film 69. The rapid-drying blower unit 73 was disposed to set the transit time of the natural air area A to 5 seconds. The velocity of the natural air was adjusted to 0.2 m/s. The dry air 57 from the rapid-drying blower unit was adjusted so as to have an air velocity of 8 m/s, a gas concentration of 16%, and a temperature of 60° C. The dry air 57 was applied to the surface of the casting film 69 to form the initial film 69a. The thickness of the casting film 69 was 100 μm, and the drying rate owing to the rapid-drying blower unit 73 was 7% by mass per second on a dry basis.

The dry air of 135° C. was sent from the upstream blower unit 70 disposed above the belt 34. Moreover, the dry air of 140° C. was sent from the downstream blower unit 71, and the dry air of 65° C. was sent from the blower unit 72 disposed under the belt 34. A saturation temperature of each dry air was about −8° C. Oxygen concentration was maintained at 5 vol % in a dry atmosphere existing on the belt 34. In order to maintain the oxygen concentration at 5 vol %, nitrogen gas was substituted for the air. Moreover, in order to condense and recover the solvent contained in the casting chamber 64, the condenser 66 was provided and an outlet temperature thereof was set to −10° C.

By the labyrinth seal 50, static pressure fluctuation was restricted within a range of Pupa or less near the casting die 31. When a solvent ratio of the casting film 69 had reached 50% by mass on a dry basis, the wet film 74 was peeled from the belt 34 while supported by the peeling roller 75. Incidentally, the solvent content on the dry basis was calculated by an expression of {(x−y)/y}×100 wherein x represents film mass of sampling time and y represents mass of the dried sampling film. Peeling tension was 1×10²N/m². Peeling velocity (peeling roller draw) was properly adjusted within a range of 100.1% to 110% relative to the velocity of the belt 34, for the purpose of preventing peeling defect. Surface temperature of the peeled wet film 74 was 15° C. Solvent gas generated due to drying was condensed by the condenser 66 of −10° C. and was recovered by the recovery device 67. The recovered solvent was adjusted so as to make moisture content 0.5% or less. The dry air from which the solvent was removed was heated again and was recycled as the dry air. The wet film 74 was carried by the rollers of the transporting section 80 and was forwarded to the tenter drier 35. In the transporting section 80, the dry air of 40° C. was applied to the wet film 74 from the air blower 81. While the wet film 74 was carried by the rollers of the transporting section 80, tension of about 30N was given to the wet film 74.

(1-8) Tenter Carrying, Drying and Edge Slitting

The wet film 74 was forwarded to the tenter drier 35, and both edges thereof were fixed by the clips. In this state, the wet film 74 was carried in the drying zone of the tenter drier 35 and was dried by the dry air therein. The clip was cooled by supplying heat transfer media of 20° C. Carrying the clip was performed by a chain, and speed fluctuation of a sprocket of the clip was 0.5% or less. Meanwhile, the inside of the tenter drier 35 was divided into three zones, the dry-air temperatures of which were respectively 90° C., 110° C. and 120° C. from the upstream side. G as composition of the dry air had a saturated gas concentration of −10° C. In the tenter drier 35, an average drying rate was 120% by mass per minute on a dry basis. Conditions of the drying zones were adjusted so as to make a remaining solvent amount of the film 82 7% by mass at an outlet of the tenter drier 35. In the tenter drier 35, it was performed not only to carry the film but also to stretch the film in the width direction. The film was stretched such that the width of the stretched film became 103%. At this time, the width of the un-stretched wet film 74 was defined as 100%. A stretch ratio (tenter driving draw) was 102% between the peeling roller 75 and the inlet of the tenter drier 35.

As to the stretch ratio in the tenter drier 35, a difference of the real stretch ratios of any two points, which were separated from a nip start position of the clip by 10 mm or more, was 10% or less. Further, a difference of the stretch ratios of any two points, which were separated from the nip start position by 20 m or more, was 5% or less. A distance extending from the nip start position to a nip release position was 90% relative to a distance extending from the inlet of the tenter drier to the outlet thereof. The solvent vaporized in the tenter drier 35 was condensed and recovered under a condition that temperature was −10° C. A condenser was provided for condensing and recovering the solvent, and an outlet temperature of the condenser was set to −8° C. The condensed solvent was recycled after adjusting the contained moisture content to 0.5% by mass or less. In the mean time, the tenter drier 35 sent out the film 82.

Both edges of the film 82 were cut by the edge slitting device 40 within thirty seconds after the film had left the outlet of the tenter drier 35. An NT-type cutter cut the edges of both sides by 50 mm. The cut edge was sent to the crusher 90 by a cutter blower (not shown) and were shredded so as to become chips of about 80 mm². This chip was utilized again as the material for preparing the dope together with the TAC flake. Oxygen concentration was maintained at 5 vol % in a dry atmosphere of the tenter drier 35. In order to maintain the oxygen concentration at 5 vol %, nitrogen gas was substituted for the air. The film 82 was preheated in a preliminary drying chamber (not shown) before performing high-temperature drying in the drying chamber 41 described below. The dry air of 100° C. was supplied into the preliminary drying chamber.

(1-9) Post-Drying and Neutralization

High-temperature drying was performed for the film 82 in the drying chamber 41. The drying chamber 41 was divided into four regions to which dry air was respectively supplied by a blower (not shown). The dry air of 120° C. was supplied to the most upstream region. The dry air of 130° C. was supplied to the other regions. Tension of the film 82 carried by the rollers 91 was 100N/m, and drying was performed for ten minutes until the remaining solvent amount finally reached 0.3% by mass. Wrap angles of the rollers were 90 degrees and 180 degrees. The roller 91 was made of either of aluminum and carbon steel, and hard chrome plating was performed for a surface thereof. Some of the rollers 91 had a flat surface shape, and the other thereof had an embossed shape processed by blast. Fluctuation of the film position caused by the rotation of the roller 91 was 50 μm or less. Deflection of the employed roller was 0.5 mm or less at the tension of 100N/m.

The solvent gas contained in the dry air was absorbed and recovered by using the absorbing device 92. Adsorbent used in this device 92 was activated carbon, and desorption was performed by using dry nitrogen. The recovered solvent was recycled as the dope preparing solvent in a state that moisture content was adjusted to 0.3% by mass or less. The dry air was recycled after removing the solvent gas, plasticizer, UV absorbent and the other high-boil ing solvent, which were contained therein, by a cooler and a pre-adsorber. The solvent amount recovered by the condensation method was 90% by mass of the entire vaporized solvent, and the remainder was almost recovered by the adsorptive recovery.

The dried film 82 was carried to a first humidity regulating chamber (not shown). Dry air of 110° C. was supplied to a transporting section disposed between the drying chamber 41 and the first humidity regulating chamber. Air having a temperature of 50° C. and a dew point of 20° C. was supplied to the first humidity regulating chamber. Successively, the film 82 was carried to a second humidity regulating chamber (not shown) for preventing the film 82 from curling. In the second humidity regulating chamber, air having a temperature of 90° C. and a humidity of 70% was directly applied to the film 82.

(1-10) Knurling and Winding Conditions

After regulating the humidity, the film 82 was cooled down to 30° C. or less in the cooling chamber 42, and then both edges of the film 82 were cut again by an edge slitting device (not shown). The neutralization device (neutralization bar) 93 was provided to constantly keep the charged voltage of the film 82 within a range of −3 kV to +3 kV during the transport of the film. Further, the knurling roller 94 performed knurling for both sides of the film 82. The knurling was formed by performing the emboss processing from the side of the film 82 and a width of the knurling was 10 mm. Pressure of the knurling roller 94 was set so as to make a height of unevenness higher than an average thickness of the film 82 by 12 μm on an average.

Successively, the film 82 was carried to the winding chamber 43 wherein temperature was maintained at 28° C. and humidity was maintained at 70%. Inside the winding chamber 43, an ionic-air neutralization device (not shown) was also provided to keep the charged voltage of the film 82 within a range of −1.5 kV to +1.5 kV. The film (a thickness of which was 80 μm) 82 obtained in this way had a product width of 1475 mm. The used winding roller 95 had a diameter of 169 mm. A pattern of tension was such that the tension was 300 N/m at the winding start side and was 200 N/m at the winding terminal side. The whole length of the wound film was 3940 m. Fluctuation of winding deviation was adapted to be 5 mm at the time of winding. A cycle of the winding deviation was 400 m relative to the winding roller 95. Pressure of the press roller 96 was set to 50N/m relative to the winding roller 95. At the time of winding, the temperature of the film 82 was 25° C., the moisture content thereof was 1.4% by mass, and the remaining solvent content thereof was 0.3% by mass. In the whole process, the average drying rate was 20% by mass per minute on a dry basis. There was no winding looseness and wrinkle, and winding deviation was not cause in an impact test of 10 G.

A film roll of the film 82 was kept on a storage rack of 25° C. and 55% RH for one month, and was examined similarly to the above. As a result, significant changes were not recognized. Further, adhesion was not recognized as well in the film roll. There was no remainder of the casting film 69, which was formed from the dope, on the belt 34 after producing the film 82.

[Evaluation of Film Surface Conditions]

The film 82 was visually observed and the surface conditions thereof were evaluated such as shown in the following.

⊚ means that the film surface was flat and smooth.

◯ means that there was extremely small unevenness although the film surface was flat and smooth.

Δ means that the film was usable for some optical films despite of small unevenness of the film surface.

X means that it was difficult to use the film for the optical film due to unevenness of the film surface.

Regarding the film 82 obtained in Experiment 1, the surface thereof was flat and smooth (⊚).

TABLE 1

| Experiment Name | Exp. 1 | Exp. 2 | Exp. 3 | Exp. 4 |
|---|---|---|---|---|
| Transit Time (s) in Natural Air | 5 | 15 | 30 | 40 |
| Area | | | | |
| Velocity (m/s) of Natural Air | 0.2 | 0.5 | 1 | 2 |
| Velocity (m/s) of Rapid Dry Air | 8 | 8 | 3 | 10 |
| Temperature (° C.) of Rapid Dry | 60 | 80 | 25 | 80 |
| Air | | | | |
| Evaluation of Film Flatness | ⊚ | ◯ | Δ | X |

From Table 1, it will be understood that the surface condition was good when the transit time in the natural air area A was 15 seconds or less. Moreover, it will be understood that the surface condition was better as the transit time was shorter. In the present invention, the rectified dry air is applied to the casting film 69 as soon as possible after casting to form the initial film 69a. It can be understood that drying the entire casting film 69 progresses as the surface condition of the initial film 69a becomes flat and smooth.

### INDUSTRIAL APPLICABILITY

The present invention is preferably applied to a method for casting a solution to produce a film to be used for an optical film.

1. A solution casting method for producing a film, comprising the steps of:
casting a dope including a polymer and a solvent, from a casting die onto an endlessly moving support;
forming a casting film of said dope on said support;
drying a surface of said casting film to form an initial film, which is regarded as a start film for forming said film, a surface condition of said casting film becoming flat and smooth in virtue of surface tension of said initial film; and
peeling said casting film from said support as said film.

2. A solution casting method according to claim 1, wherein said initial film is formed by applying dry air to said casting film.

3. A solution casting method according to claim 2, wherein the surface of said casting film passes through an air, a velocity of which is less than 3 m/s, before applying said dry air to said casting film, and a transit time thereof is set to 10 seconds or less.

4. A solution casting method according to claim 2, wherein a velocity of said dry air is set to a range of 3 m/s to 20 m/s.

5. A solution casting method according to claim 2, wherein said dry air is applied to said casting film for twenty seconds or more.

6. A solution casting method according to claim 2, wherein a gas concentration of said dry air is 25% or less.

7. A solution casting method according to claim 2, wherein a temperature of said dry air is 40° C. or more and 120° C. or less.

8. A solution casting method according to claim 2, wherein said dry air is applied to the surface of said casting film from a plurality of nozzles disposed above said casting film.

9. A solution casting method according to claim 8, wherein said nozzle is a slit nozzle.

10. A solution casting method according to claim 1, wherein said initial film is formed within fifteen seconds after said casting film has been formed on said support.

11. A solution casting method according to claim 1, wherein a remaining solvent amount of said casting film is 300% by mass or more and 500% by mass or less on a dry basis at a time when drying the surface of said casting film is started.

12. A solution casting method according to claim 1, further comprising the step of;
drying said film, a thickness of the dried film is 40 μm or more and 120 μm or less.

13. A solution casting method according to claim 1, wherein a diminution rate of the solvent included in said casting film is 1% by mass per second or more and 12% by mass per second or less on a dry basis until thirty seconds has passed after applying said dry air.

14. A solution casting method according to claim 1, wherein a viscosity of said dope is 10 Pa·s or more and 100 Pa·s or less at a time of casting.

15. A solution casting method according to claim 1, wherein casting said dope is performed by co-casting.

16. A solution casting method according to claim 1, wherein a movement speed of said support is 10 m/minute or more and 200 m/minute or less.

17. A solution casting method according to claim 16, wherein said support is an endless belt driven by two rollers.

18. A solution casting method according to claim 17, wherein said casing die is disposed near one of said rollers.

19. A solution casting method according to claim 1, wherein said polymer is cellulose acylate.

20. A solution casting method according to claim 1, wherein said film is used for an optical film.
